(19) United States
(12) Patent Application Publication
(10) Pub. No.: US 2025/0349075 A1
(43) Pub. Date: Nov. 13, 2025

(54) TECHNIQUES FOR GENERATING CONTOUR LINES FOR 3D MAPS

(71) Applicant: Apple Inc., Cupertino, CA (US)

(72) Inventors: Daniel W. Zaide, San Jose, CA (US); Adam Ali, Cupertino, CA (US); Syed Mohsin Hasan, Sunnyvale, CA (US); Miguel C. Vieira, San Carlos, CA (US)

(73) Assignee: Apple Inc., Cupertino, CA (US)

(21) Appl. No.: 19/184,896

(22) Filed: Apr. 21, 2025

Related U.S. Application Data
(60) Provisional application No. 63/645,099, filed on May 9, 2024.

(51) Int. Cl. G06T 17/05; G06T 3/40; G06T 15/20; G06T 15/40; G06T 17/20

(52) U.S. Cl. CPC G06T 17/05; G06T 3/40; G06T 15/20; G06T 15/40; G06T 17/20; G06T 2200/04; G06T 2210/36; G06T 2210/62

(57) ABSTRACT

Techniques for generating three-dimensional contour lines are described herein. The techniques can include determining whether one or more segments of the set of three-dimensional contour lines are obscured by a first terrain mesh when viewed from the first viewpoint. In accordance with a determination that the one or more segments of the set of three-dimensional contour lines are obscured by the first terrain mesh a depth bias can be applied to the one or more segments of the set of three-dimensional contour lines.

### CROSS-REFERENCES TO RELATED APPLICATIONS

This application claims the benefit of U.S. Provisional Application No. 63/645,099, filed on May 9, 2024, which is incorporated by reference.

### BACKGROUND

With the proliferation of mobile devices, electronic maps are used by a variety of services and applications. Some uses for electronic maps can include directions (such as for driving) or for presenting information related to specific geographic locations. Electronic maps can use a variety of visual methods to communicate distinctions and information regarding the map. Three-dimensional maps have become popular; however, there are challenges with presenting them in a useful way.

### SUMMARY

A system of one or more computers can be configured to perform particular operations or actions by virtue of having software, firmware, hardware, or a combination of them installed on the system that, in operation, causes the system to perform the actions. One or more computer programs can be configured to perform particular operations or actions by virtue of including instructions that, when executed by data processing apparatus, cause the apparatus to perform the actions. One general aspect includes a computer-implemented method. The techniques (e.g., the system, programs, and/or computer-implemented method) can include identifying a set of three-dimensional contour lines corresponding to a first terrain mesh of a three-dimensional map. The techniques can also include receiving a request to display a first viewpoint of a second terrain mesh of at least a portion of the three-dimensional map with three-dimensional contour lines, wherein the second terrain mesh is different from the first terrain mesh. The techniques can include determining whether one or more segments of the set of three-dimensional contour lines are obscured by the second terrain mesh when viewed from the first viewpoint. In accordance with a determination that the one or more segments of the set of three-dimensional contour lines are obscured by the second terrain mesh, a depth bias can be applied towards the first viewpoint to the one or more segments of the set of three-dimensional contour lines and displaying the first viewpoint of the second terrain mesh and the set of three-dimensional contour lines. Other embodiments of this aspect include corresponding computer systems, apparatus, and computer programs recorded on one or more computer storage devices, each configured to perform the actions of the techniques.

### BRIEF DESCRIPTION OF THE DRAWINGS

FIG. 1 illustrates a diagram of an example map view, according to an embodiment of the present disclosure.

FIG. 2 illustrates a progression of viewpoints of a three-dimensional map and visual artifacts associated with and three-dimensional contour lines and techniques to reduce and/or eliminate the visual artifacts, according to an embodiment of the present disclosure.

FIG. 3 illustrates a block diagram of a process for generating three-dimensional contour lines and adjusting three-dimensional contour lines to remove or eliminate visual artifacts, according to an embodiment of the present disclosure.

FIG. 4 illustrates a diagram for applying a depth bias to a three-dimensional contour line, according to an embodiment of the present disclosure.

FIG. 5 illustrates a simplified flow diagram for performing the techniques described herein, according to an embodiment of the present disclosure.

FIG. 6 illustrates a progression of viewpoints of a three-dimensional map when adjusting pitch of the viewpoint, according to an embodiment of the present disclosure.

FIG. 7 illustrates a simplified flow diagram for performing the techniques described herein, according to an embodiment of the present disclosure.

FIG. 8 illustrates a block diagram of devices that can implement at least some parts of the techniques described herein, according to an embodiment of the present disclosure.

FIG. 9 illustrates an example architecture or environment configured to implement the techniques described herein, according to an embodiment of the present disclosure.

### DETAILED DESCRIPTION

Certain embodiments of the present disclosure relate to devices, computer-readable medium, and methods for implementing various techniques for generating three-dimensional contour lines for three-dimensional (also referred to as 3D or 3-D) maps. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

On a map view, for example, an electronic map view, there can be a variety of features shown, for example buildings, homes, roads, water features, vegetation, and elevation. Map views can have varying levels of detail and may omit one or more of such features. In some implementations, the map view could be a three-dimensional map view where depth and elevation information can be presented, simulated, or viewed. For example, the terrain of a geographical area can be shown on a three-dimensional map allowing for mountains, valleys, and other variations in height and elevation to be shown in the map view. A map view can include a viewpoint from which the map view can be seen. For example, a viewpoint can be from a bird's eye view (for example, a view looking down on the featured location). Map views can also be adjusted to view locations from other perspectives, angles, or viewpoints. For example, a map view could be from a 45-degree angle viewpoint (also referred to as a pitch of 45-degrees) from the horizon, sea level, or flat ground. Similarly, a map view could be zoomed out to view a larger location at a lower zoom level (for example, less zoomed in) or zoomed in to view a smaller location at a higher zoom level (for example, more zoomed in). In some examples, different map view data may have one or more respective zoom levels, corresponding to relative amounts of zoom. The variation in viewing angle and perspective and zoom can lead to variation in the number of features viewable on the map.

An electronic map can be composed of layers, with each layer providing different details and/or features. Some of these layers can be represented as three-dimensional meshes (also referred to as polygon meshes). For example, a terrain layer (which can also be referred to as a terrain three-dimensional mesh or terrain mesh) can depict the variation in elevation and height of a location on a display. There can also be a three-dimensional building mesh, which provides simulated heights of buildings in a map view. The techniques described herein are described as applying to terrain meshes, but they can be applied to any three-dimensional mesh including building meshes.

Three dimensional meshes can be used to create surfaces in three dimensions by being formed by a series of vertices and edges. Connections are created between the vertices to outline the surfaces created by the three-dimensional mesh. For example, a three-dimensional mesh can be used to create a surface that appears to be part of a side of a mountain. There are many types of three-dimensional meshes. One example type of three-dimensional mesh is a triangular mesh. In a triangular mesh, all constituent segments of the mesh are triangles; the vertices of the mesh are connected to create triangles. Another example type of three-dimensional mesh is a polygon mesh. In a polygon mesh, all constituent segments of the mesh can be any type of polygon. Any suitable type of three-dimensional mesh can be used. As described herein, any techniques that apply to terrain meshes can apply to any three-dimensional mesh. High fidelity three-dimensional meshes will have higher density of vertices, edges, and surfaces. Low fidelity three-dimensional meshes will have lower density of vertices, edges, and surfaces.

However, generating a three-dimensional map using three-dimensional meshes can require significant computing resources. Adding/drawing any three-dimensional features (for example trees, buildings, three-dimensional contour lines) uses significant computational resources, power resources, data storage resources and/or data transmission resources. The amount of computing resources needed to draw three-dimensional features can depend on the fidelity of the three-dimensional mesh. For example, a terrain mesh shown on the map from a lower zoom level (for example, zoom levels that are from a viewpoint further away from the subject of the view or less zoomed in) can show more area and usually have less detail, such a terrain mesh can be considered a low or lower fidelity terrain mesh. In this example, lower zoom levels can show a terrain mesh with less elevation detail for every small hill or valley across the terrain mesh to bring computational resources and power resources within certain performance requirements (for example, for a mobile device with limited computing resources). Conversely, a terrain mesh that is shown at higher zoom levels (for example, more zoomed in) can have more detail including elevation detail, such a terrain mesh can be considered a high or higher fidelity terrain mesh. Moving between these zoom levels can use significant computational resources and/or communication resources (for example, transmitting and receiving terrain information from a server via a wireless network or other signal).

Maps can also include contour lines to convey information regarding elevation. Contour lines are used as an approximation to convey points or locations that have a constant elevation on two-dimensional (also referred to as 2D or 2-D) maps. Such contour lines can be referred to as two-dimensional contour lines. Some electronic maps can switch between a two-dimensional mode and a three-dimensional mode. Due to the proliferation of two-dimensional maps, an electronic map may have a default mode of a two-dimensional map. When the electronic map is in a two-dimensional mode, the electronic map can use contour lines to denote elevation information. Contour lines are considered to be a feature of two-dimensional maps because three-dimensional maps can convey elevation information through the use of the third dimension (also referred to as the z-axis, elevation information, or height information). However, the techniques herein describe how three-dimensional contour lines can be useful and convey information in a three-dimensional map. For example, a three-dimensional map can still be viewed from a bird's eye viewpoint and three-dimensional contour lines can convey elevation information without requiring a change to a viewpoint with a non-O-degree pitch value. A three-dimensional map viewed from a bird's eye viewpoint can cause the terrain mesh of the three-dimensional map to appear similar to the surface of a two-dimensional map.

Adding contour lines to a three-dimensional map can include contour lines that themselves are three-dimensional (also referred to as three-dimensional contour lines). In this way, the three-dimensional contour lines themselves can include z-axis information such as a z-axis location value and z-axis height/thickness value. In this way, as the pitch of a viewpoint of the map changes from a bird's eye viewpoint (for example, a 0-degree pitch), the z-axis information of the three-dimensional contour lines can be observed.

Three-dimensional contour lines can be generated based on two-dimensional contour lines. Generating three-dimensional contour lines from two-dimensional contour lines can use a method known as draping for adding a third-dimension to a two-dimensional object that will overlay a three-dimensional object. Draping can be performed using vector data. Vector data for the three-dimensional object can be used to add the third-dimension to a two-dimensional object. Two-dimensional contour lines can be draped onto a terrain mesh to create three-dimensional contour lines that match the terrain mesh. The two-dimensional contour lines can use vector data related to corresponding polygons of the terrain mesh over which the two-dimensional contour lines are being draped. However, the terrain mesh may not match the two-dimensional contour lines such that contour lines maintain a constant elevation in the z-axis. Nonetheless, the three-dimensional contour lines can be accurate and precise enough to convey an approximation of locations or points that have the same elevation. When the three-dimensional contour lines are draped onto a two-dimensional contour lines, there may be no visual artifacts. For example, the three-dimensional contour lines can perfectly rest on the terrain mesh. Draping can also be used to overlay three-dimensional features onto a three-dimensional mesh. Overlaying a three-dimensional feature onto a three-dimensional mesh is even more costly in computational resources than overlaying a two-dimensional feature onto a three-dimensional mesh.

In order to drape two-dimensional contour lines onto a terrain mesh to generate a three-dimensional contour line, there may need to be two-dimensional contour lines created from a source of information. In some examples, two-dimensional contour lines can be generated from terrain meshes that serve as the source of information. In other examples, the two-dimensional contour lines can be generated from another source of information. In the example where terrain meshes serve as the source of information for the two-dimensional contour lines, a terrain mesh at a lower zoom level (for example, less zoomed in) as compared to a terrain mesh used to generate three-dimensional contour lines as described herein with less detailed changes in elevation may be particularly useful in generating the two-dimensional contour lines. This may be beneficial to reduce the amount of information that is stored for the two-dimensional contour lines as higher detail two-dimensional contour lines may require more data and data storage. Furthermore, lower detailed two-dimensional contour lines may require fewer computing resources to drape onto a different terrain mesh.

As described above, adding/drawing any three-dimensional features (for example trees, buildings, three-dimensional contour lines) uses significant computational resources, power resources, data storage resources and/or data transmission resources. Thus, generating three-dimensional contour lines for every terrain mesh at every zoom level may be prohibitively costly for these resources. Generating three-dimensional contour lines for each piece of terrain mesh at each zoom level may require too many computational resources, power resources, and/or data storage resources for some devices. Furthermore, offloading the computational resources, power resources, and/or data storage resources to a server can lead to costly use of data transmission resources. Contour lines, both two-dimensional and three-dimensional, are seen as an approximation of elevation information. Therefore, near perfect precision and accuracy of both two-dimensional and three-dimensional contour lines may not been necessary or provide significant benefits. Therefore, the generation of three-dimensional contour lines can follow a best effort approach that conveys approximate elevation information in a useful way.

In some examples, the three-dimensional contour lines may not perfectly overlay a terrain mesh. For example, the three-dimensional contour lines may intersect with the terrain mesh to produce a clipping effect. From a viewpoint, segments of the three-dimensional contour lines may seem to disappear because the terrain mesh may obscure, cover, or overlay the segments of the three-dimensional contour lines. The clipping effect causing segments of the three-dimensional contours to disappear can be referred to as a visual artifact. A depth bias can be applied to the segments of the three-dimensional contour lines that are obscured by the terrain mesh. This depth bias would bring the segments of the three-dimensional contour lines closer to the viewpoint. This depth bias can be a vector to move points or segments of the three-dimensional contour lines closer to the viewpoint. In this way, the three-dimensional contour lines will be closer to the viewpoint than the terrain mesh and thus be viewable again and not obscured by the terrain mesh. Applying a depth bias can be a low-computational-resource method to remove the visual artifacts caused by the clipping of the three-dimensional contour lines and the terrain mesh. This is especially true when compared to draping the three-dimensional contour lines onto the three-dimensional terrain mesh as described above. Applying a depth bias may be a viable way for a device with limited computational resources (for example, a mobile device such as a smartphone, tablet, laptop, smartwatch, or other device that runs using localized battery power) to eliminate the visual artifacts from the clipping described herein. In some examples, the depth bias can be applied to the entire contour line. In some examples, the depth bias can be applied to particular segments of the contour line.

Turning now to a particular example, a user may be using a map application on their cellular phone (for example, a smartphone) to view an electronic map. The user may begin viewing the electronic map via a two-dimensional mode depicting a two-dimensional map (also referred to as a two-dimensional version of the map). The two-dimensional map can contain contour lines to depict approximations for elevation information on the two-dimensional map. However, the electronic map may also have a three-dimensional mode depicting a three-dimensional map. in some examples, the user may switch to the three-dimensional mode. In order to display the three-dimensional electronic map, the smartphone may generate or receive a first set of terrain meshes to depict a three-dimensional map. In this example, a server may transmit the first set of terrain meshes to the smartphone. Similarly, the server may also transmit the three-dimensional contour lines to be displayed on the first set of terrain meshes. The server may have generated the three-dimensional contour lines by draping two-dimensional contour lines onto the first set of terrain meshes transmitted to the smartphone. The smartphone can receive and display the first set of terrain meshes and the three-dimensional contour lines. In this example, the three-dimensional contour lines may perfectly overlay the first set of terrain meshes when displayed as an electronic map by the smartphone.

Turning to a second example, the smartphone may again generate or receive the first set of terrain meshes to depict the three-dimensional map. However, this time to conserve computational resources (for example, computing resources, data storage resources, and data transmission resources), the server may generate the three-dimensional contour lines by draping two-dimensional contour lines onto a second set of terrain meshes rather than on the first set of terrain meshes. The second set of terrain meshes may have less detail (for example, have a set of lower fidelity terrain meshes) than the first set of terrain meshes, thus draping the two-dimensional contour lines onto the second set of terrain meshes may require less computational resources than draping the two-dimensional contour lines onto the first set of terrain meshes. Not only are the computing resources and data storage resources for the server reduced, but the data transmission resources can also be reduced by having less detailed three-dimensional contour lines. The smartphone can receive the first set of terrain meshes and the three-dimensional contour lines. Here, the smartphone can apply a depth bias to the segments of the three-dimensional contour lines to cause the segments to appear over or overlay the first set of terrain meshes. The depth bias may require fewer computational resources than draping the three-dimensional contour lines onto the first set of terrain meshes at the smartphone (which the smartphone is capable of doing but may be too costly in terms of resources).

Turning to a third example, the smartphone may be displaying a three-dimensional map using a third set of terrain meshes and corresponding three-dimensional contour lines. The corresponding three-dimensional contour lines can be three-dimensional contour lines created by draping two-dimensional contour lines onto the third set of terrain meshes or by applying a depth bias to a set of three-dimensional contour lines that were generated from a fourth set of terrain meshes. Here, a user may zoom into the three-dimensional map. The smartphone may need to request and/or generate a fifth set of terrain meshes for the new zoomed in terrain. Because the fifth set of terrain meshes represent a more zoomed in version of the three-dimensional map, the fifth set of terrain meshes may be higher fidelity than the third set of terrain meshes. This may cause segments of the three-dimensional contour lines used for the third set of terrain meshes to clip with the fifth set of terrain meshes when displayed as a three-dimensional map on the smartphone. Here, the smartphone can again apply a depth bias to the segments of the three-dimensional that clip with the fifth set of terrain meshes to cause those segments to appear over or overlay the fifth set of terrain meshes.

Using depth bias to adjust contour lines can be useful when the viewpoint of the three-dimensional map is at a low pitch value (for example, 30 degrees from the X-Y plane). However, as pitch value increases and the user is able to see more z-axis information, the depth bias of three-dimensional contour lines may produce visual artifacts. Additionally, the user may have a decreased need for the elevation information conveyed by the three-dimensional contour lines as the user is able to see more of the elevation information from the new viewpoint. As such, the three-dimensional contour lines may be less useful.

In order to solve this problem, the three-dimensional contour lines can be animated to fade and/or disappear as the pitch value of a viewpoint of the three-dimensional map increases. For example, the three-dimensional contour lines can decrease opacity as the user causes the viewpoint of the three-dimensional map to have an increased pitch value. In some examples, the three-dimensional contour lines can have a minimum opacity value. The minimum opacity value can be reached after the pitch value reaches and exceeds a threshold value. In some examples, the three-dimensional contour lines can have a maximum opacity value. The maximum opacity value can be used for the pitch value at or below a second threshold value.

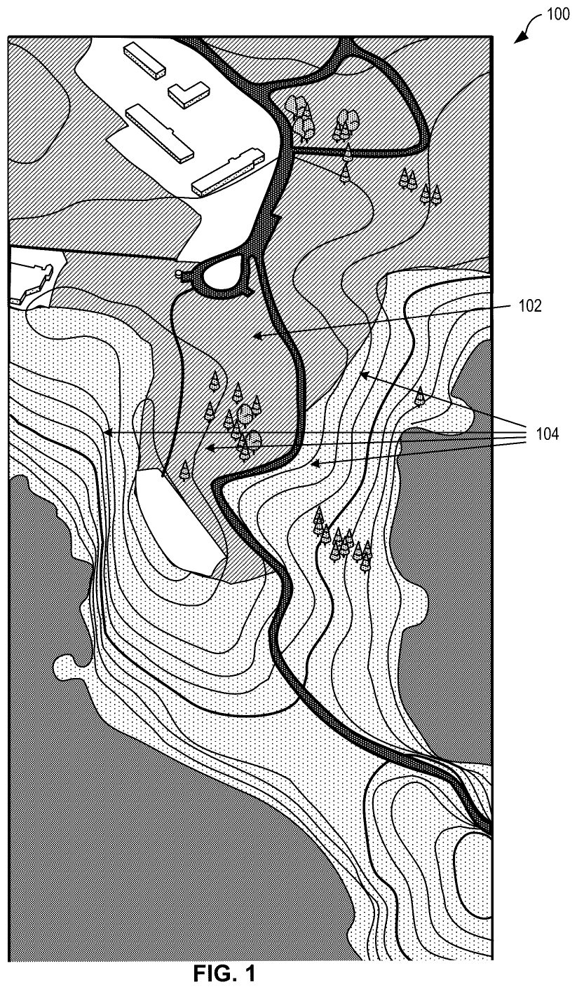

FIG. 1 illustrates a diagram illustrating an example map view 100. Map view 100 is from a bird's eye viewpoint (for example, a viewpoint with 0-degree pitch value). Map view 100 can be a viewpoint of a three-dimensional mode of an electronic map. In some examples, a viewpoint can be referred to as a view or map view. In some examples, a viewpoint can be referred to as the point or location from which a view is perceived by the viewer. The map view 100 can include a terrain mesh 102 and contour lines 104 that represent locations that have approximately the same elevation. The terrain mesh 102 is a three-dimensional mesh that represents the terrain information related to the three-dimensional representation of the map view 100. The terrain mesh 102 can include changes in elevation such as hills, valleys, cliffs, peaks, craters and the like. The contour lines 102 can also convey elevation information. All points along a single contour line can have approximately the same elevation. When viewed from a bird's eye viewpoint, the contour lines 104 can have 100% opacity. The contour lines 104 also present elevation information for the viewpoint of a bird's eye view. In FIG. 1, the contour lines 104 may have been draped onto the terrain mesh. A different viewpoint with a different pitch value can present the elevation information of the three-dimensional map via the terrain mesh 102.

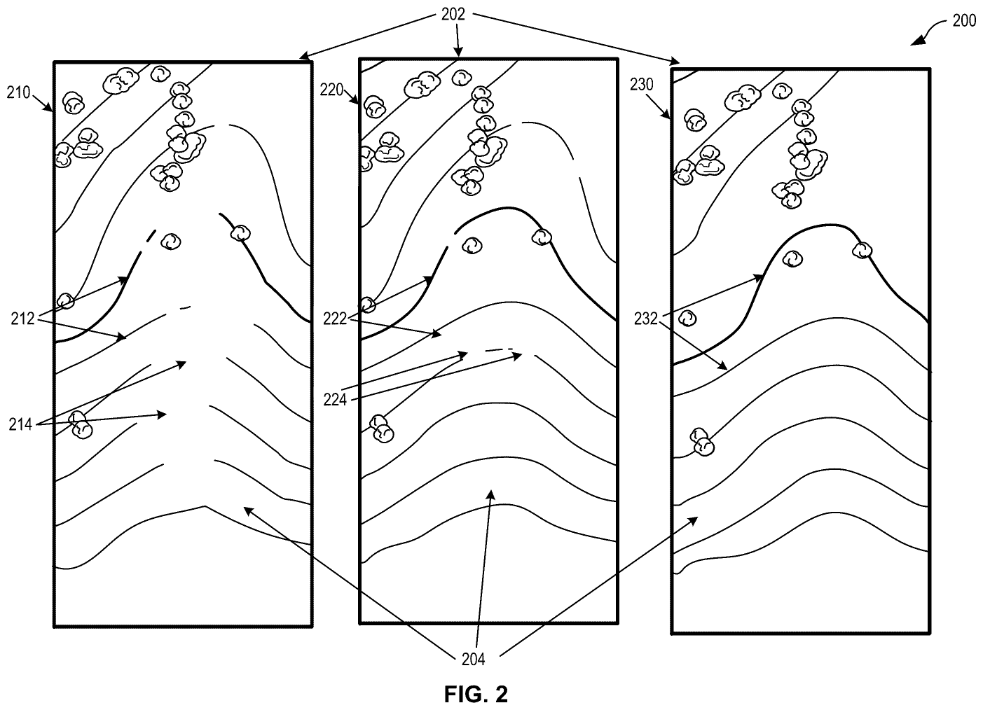

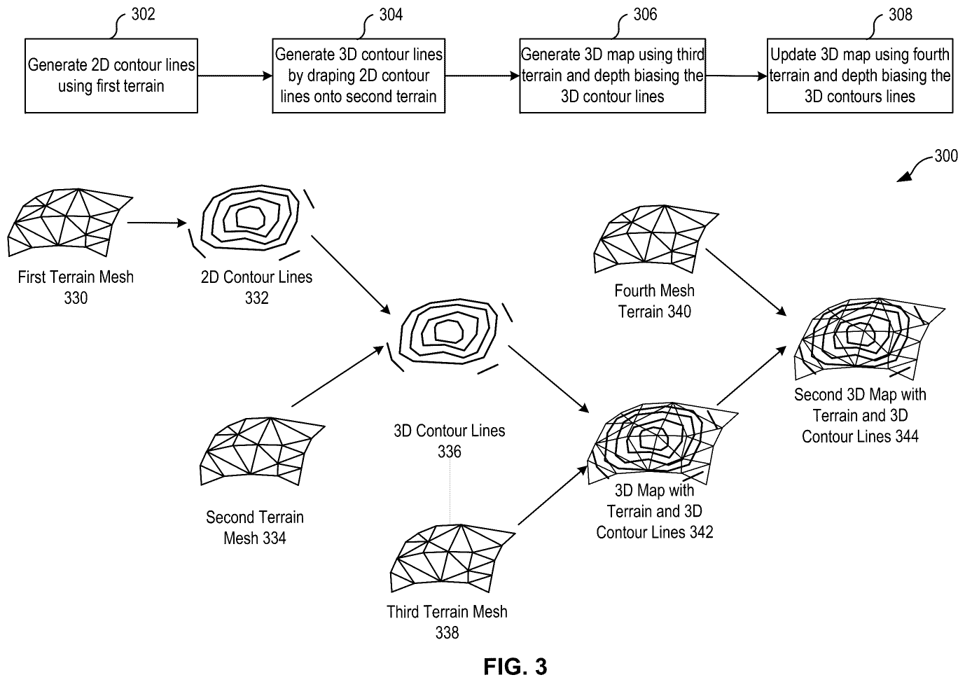

FIG. 2 illustrates a progression 200 of viewpoints 210, 220, 230 of the three-dimensional map 202 in order to illustrate visual artifacts associated with three-dimensional contour lines 212, 222, 232 and techniques to reduce and/or eliminate the visual artifacts. FIG. 2 depicts a progression of steps to reduce visual artifacts on the same three-dimensional map 202 with the same terrain mesh 204 from a viewpoint with a 0-degree pitch value. Overhead views of trees are depicted on the three-dimensional map 202 to demonstrate features that can be presented. FIG. 2 can include example three-dimensional contour lines 212, 222, 232. In this example, two-dimensional contour lines (not shown here) were generated based on a first terrain mesh (not shown here) or other elevation information and not generated based on the terrain mesh 204. The generation of two-dimensional contour lines based on the first different terrain mesh is further described in relation to FIG. 3, for example block 302.

From the 0-degree pitch viewpoint 210, the three-dimensional contour lines 212 can be seen to include visual artifacts known as clipping. The visual artifacts can occur because the contour lines 212 were generated based on a first terrain mesh (not shown here) rather than terrain mesh 204. The segments 214 of the contour lines 212 may appear to disappear from the viewpoint 210, however the segments 214 can be obscured by the terrain mesh 204. The elevation information for those segments 214 of the three-dimensional contour lines 212 may have a lower z-axis value such that the segments 214 are actually drawn on the three-dimensional map but behind the terrain mesh 204 such that the segments 214 cannot be seen from the viewpoint 210. Even if a new viewpoint is used with a different pitch value, the segments 214 may be obscured by the terrain mesh 204.

From the 0-degree pitch viewpoint 220, the three-dimensional contour lines 222 can be seen to include fewer visual artifacts. Again, segments 224 are obscured by the terrain mesh 204. The elevation information for those segments 224 of the three-dimensional contour lines 222 may have a lower z-axis value such that the segments 224. Here, the visual artifacts may be reduced because the contour lines 222 were generated by draping the two-dimensional contour lines (generated from the first terrain mesh) onto a second terrain mesh (not shown here) more similar to the terrain mesh 204 than the first terrain mesh. The generation of three-dimensional contour lines based on the second different terrain mesh and the two-dimensional contour lines is further described in relation to FIG. 3, for example block 304. Although not seen in relation to viewpoint 220, the other segments of the three-dimensional contour lines 222 may appear to float above the terrain mesh 204 if viewed from a viewpoint with a greater pitch value than 0. The elevation information for these segments of the three-dimensional contour lines 222 may have a higher z-axis value.

From the 0-degree pitch viewpoint 230, the three-dimensional contour lines 232 can be seen to have no visual artifacts. Here, there are no segments of the three-dimensional contour lines 232 that are obscured by the terrain mesh 204. A depth bias has been applied to the segments 224 to move the segments 224 towards the viewpoint 230 such that the terrain mesh 204 no longer obscures the segments 224. The depth bias can be a vector that can be applied to the segments 224 and/or points of the segments. Similarly, others segments of the three-dimensional contour lines 232 that would appear to float above the terrain mesh 204 (not shown here) can have a depth bias applied to the segments to move the segments away from the viewpoint 230 such that the segments rest and/or overlay the terrain mesh 204.

FIG. 3 illustrates an example process 300 for generating three-dimensional contour lines and adjusting three-dimensional contour lines to remove or eliminate visual artifacts. In some examples, a single electronic device can perform all steps of process 300. For example, a smartphone can perform process 300. In some examples, two or more electronic devices can be used to perform steps of process 300. For example, one or more steps may be performed by a server and one or more other steps may be performed by a smartphone.

Process 300 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some examples, process 300 can include generating two-dimensional contour lines using first terrain at block 302. A first terrain mesh 330 can be used to represent terrain information for a corresponding geographic location. Two-dimensional contour lines 332 can be generated based at least in part on the first terrain 330. The two-dimensional contour lines 332 can be used to represent any interval of elevation information such that the difference between adjacent two-dimensional contour lines can be adjusted to any amount. For example, two-dimensional contour lines 332 can have an interval of 1000 feet or 1000 meters, or any other suitable interval of distance. In some examples, the first terrain mesh 330 can be a low fidelity terrain mesh that is meant to represent larger changes in elevation for the corresponding geographic location. In this example, generating two-dimensional contour lines 332 from a low fidelity terrain mesh can use fewer computational resources and may require fewer resources to transmit to another device. In some examples, the two-dimensional contour lines 332 can be generated using other information than a three-dimensional mesh. For example, the two-dimensional contour lines 332 can be generated based on a database of elevation information.

In some examples, process 300 can include generating three-dimensional contour lines by draping two-dimensional contour lines onto second terrain at block 304. The two-dimensional contour lines 332 can be draped onto the second terrain mesh 334 to generate three-dimensional contour lines 336. As described herein, draping can include adding z-axis information to a two-dimensional shape based on a three-dimensional object. The two-dimensional shape can take on the z-axis values of the underlying three-dimensional object along vertices matching the three-dimensional object. This can also be referred to as overlaying the two-dimensional shape onto the three-dimensional object. Here, three-dimensional contour lines 336 can be generated based on the two-dimensional contour lines 332 and the second terrain mesh 334. The three-dimensional contour lines 336 can add the z-axis information for the second terrain mesh 334 to the two-dimensional information of the contour lines 332. The two-dimensional contour lines 332 and the second terrain mesh 334 can be aligned using their respective X-Y plane information. Draping can be performed using vector data. Vector data for the three-dimensional object can be used to add the third-dimension to a two-dimensional object. For example, the two-dimensional contour lines 332 can use vector data related to corresponding polygons of the second terrain mesh 334 over which the two-dimensional contour lines 332 are being draped. In some examples, the second terrain mesh 334 can be the same terrain mesh as the first terrain mesh 330. In some examples, the second terrain mesh 334 can be a different terrain mesh than the first terrain mesh 330. For example, the second terrain mesh 334 may be a medium fidelity terrain mesh such that the second terrain mesh 334 has higher fidelity than the first terrain mesh 330. In this way, the second terrain mesh 334 may include more elevation information and detail than the first terrain mesh 330.

In some examples, when draping the two-dimensional contour lines 332 over the second terrain mesh 334, multiple sources of truth are being combined. The first terrain mesh 330 can serve as the source of truth for the two-dimensional contour lines 332. However, the three-dimensional contour lines 336 can combine the source of truth of the two-dimensional contour lines 332 and the source of truth of the second terrain mesh 334. This can cause the three-dimensional contour lines 336 to not exist in a flat X-Y plane. For example, a three-dimensional contour line may be flat in an X-Y plane such that all points on the three-dimensional contour line have the same z-axis value. However, when the first terrain mesh 330 and the second terrain mesh 334 do not match, a three-dimensional contour lines 336 generated from the two-dimensional contour lines 332 and the second terrain mesh 334 may not be flat in an X-Y plane such that all points have the same z-axis value. In this way, the three-dimensional contour lines 336 can be referred to as being divergent from the source of truth that is the first terrain mesh 330. In some examples, it may be preferable to have the second terrain mesh 334 has higher fidelity than the first terrain mesh 330 in order to generate higher fidelity three-dimensional contour lines 336 that contain more elevation information than captured in the two-dimensional contour lines 332. As noted herein, both two-dimensional contour lines 332 and three-dimensional contour lines 336 are visual approximations of elevation information and thus may not need to be absolutely precise or accurate.

In some examples, process 300 can include generating a three-dimensional map with three-dimensional contour lines based on the three-dimensional contour lines and a third terrain at block 304. Block 304 can also include depth biasing segments of the three-dimensional contour lines. The three-dimensional contour lines 336 can be combined with a third terrain mesh 338 to generate a three-dimensional map with terrain and three-dimensional contour lines 342. In some examples, the third terrain mesh 338 can be a same terrain mesh as the first terrain mesh 330 and/or the second terrain mesh 334. In some examples, the third terrain mesh 338 can be a high-fidelity three-dimensional terrain mesh with higher fidelity than the first terrain mesh 330 and the second terrain mesh 334. By using lower fidelity three-dimensional meshes to generate the two-dimensional contour lines 332 and the three-dimensional contour lines 336, the three-dimensional contour lines can be less detailed and thus consume fewer computing resources such as computational resources, data storage resources, power resources, and data transmission resources. In some examples, the two-dimensional contour lines 332 and the three-dimensional contour lines 336 can be generated on a first device and transmitted to a second device. For example, the two-dimensional contour lines 332 and the three-dimensional contour lines 336 can be generated on a server and transmitted to a mobile device to display via a map application on the mobile device.

In some examples, when the three-dimensional contour lines 336 and the third terrain mesh 338 are combined, the resulting three-dimensional map with terrain and three-dimensional contour lines 342 may include visual artifacts as described in relation to FIG. 2 and viewpoint 210 such as clipping of the three-dimensional contour lines with the terrain mesh of the three-dimensional map. The visual artifacts of the three-dimensional map 342 can occur because the three-dimensional contour lines 336 were generated based on a second terrain mesh 334 rather than third terrain mesh 338. Certain segments of the three-dimensional contour lines 336 may appear to disappear, however the segments can be obscured by the third terrain mesh 338 (or more specifically one or more terrain polygons of the third terrain mesh 338). The elevation information for those segments of the three-dimensional contour lines 336 may have a lower z-axis value such that the segments are actually drawn on the three-dimensional map 342 but behind the third terrain mesh 338 such that the segments cannot be seen.

In some examples, process 300 can include applying a depth bias to segments of the three-dimensional contour lines. Segments of the three-dimensional contour lines 336 that are mismatched to the third terrain mesh 338 can be identified by a variety of methods. Intersections between the three-dimensional contour lines 336 and the third terrain mesh 338 can be identified and used to determine segments that are not viewable for being behind the third terrain mesh 338. Alternatively, the z-axis values of points on the three-dimensional contour lines 336 can be compared to the z-axis values of corresponding points on the third terrain mesh 338 to determine when there is a mismatch exceeding a threshold value. For example, the z-axis values of points on the three-dimensional contour lines 336 can be too great or too small in comparison to the z-axis values of corresponding points on the third terrain mesh 338. In some examples, a depth bias can be applied to the mismatched segments to move the segments towards a viewpoint from which the three-dimensional map 342 is presented such that the third terrain mesh 338 no longer obscures the segments of the three-dimensional contour lines 336. Similarly, others segments of the three-dimensional contour lines 336 that would appear to float above the third terrain mesh 338 can have a depth bias applied to the segments to move the segments away from the viewpoint from which the three-dimensional map 342 is presented such that the segments rest and/or overlay the third terrain mesh 338. The depth bias can be a vector that can be applied to the segments and/or points of the segments.

Using depth bias to fix visual artifacts of three-dimensional contour lines 336 can be preferable to save computing resources such as computational resources, power resources, data storage resources, and data transmission resources. This can be especially important when the generation of the three-dimensional map 342 occurs on a mobile device with limited computing resources. Using depth bias to fix visual artifacts may be preferable to draping the three-dimensional contour lines 336 onto the third terrain mesh 338 locally due to the computing resource requirements of draping.

In some examples, process 300 can include updating a three-dimensional map using fourth terrain and depth biasing the three-dimensional contour lines. In some examples, a user may change the zoom level of the three-dimensional map being displayed on their device. This can cause a new fourth terrain mesh 340 to be presented on the three-dimensional map application. The fourth terrain mesh 340 can be related to the third terrain mesh 338. In some examples, the fourth terrain mesh 340 may be a lower zoom level (for example, less zoomed in) than the third terrain mesh 338 such that a portion of the fourth terrain mesh 340 corresponds to the third terrain mesh 338. In some examples, the fourth terrain mesh 340 may be a higher zoom level (for example, more zoomed in) than the third terrain mesh 338 such that the fourth terrain mesh 340 corresponds to a portion of the third terrain mesh 338. By changing the zoom level and using a new terrain mesh, the visual artifacts such as clipping three-dimensional contour lines and floating three-dimensional contour lines can occur on the second three-dimensional map 344. The segments of the three-dimensional contour lines of the three-dimensional map 342 that produce visual artifacts on the second three-dimensional map 344 can be identified in similar ways as described in relation to block 306 and the three-dimensional contour lines 336. Depth bias can be used on the three-dimensional contour lines of the three-dimensional map 342 to match the segments of the three-dimensional contour lines to the second three-dimensional map 344. In some examples, a depth bias can be applied to the mismatched segments of the three-dimensional contour lines from the three-dimensional map 342 to move the segments towards a viewpoint from which the second three-dimensional map 344 is presented such that the fourth terrain mesh 340 no longer obscures the segments of the three-dimensional contour lines of three-dimensional map 342. Similarly, others segments of the three-dimensional contour lines from the three-dimensional map 342 that would appear to float above the fourth terrain mesh 340 can have a depth bias applied to the segments to move the segments away from the viewpoint from which the three-dimensional map 344 is presented such that the segments rest and/or overlay the fourth terrain mesh 340.

Using depth bias to fix visual artifacts of three-dimensional contour lines can be preferable to save computing resources such as computational resources, power resources, data storage resources, and data transmission resources. This can be especially important when the generation of the second three-dimensional map 344 occurs on a mobile device with limited computing resources. Using depth bias to fix visual artifacts may be preferable to draping the three-dimensional contour lines onto the fourth terrain mesh 340 locally due to the computing resource requirements of draping.

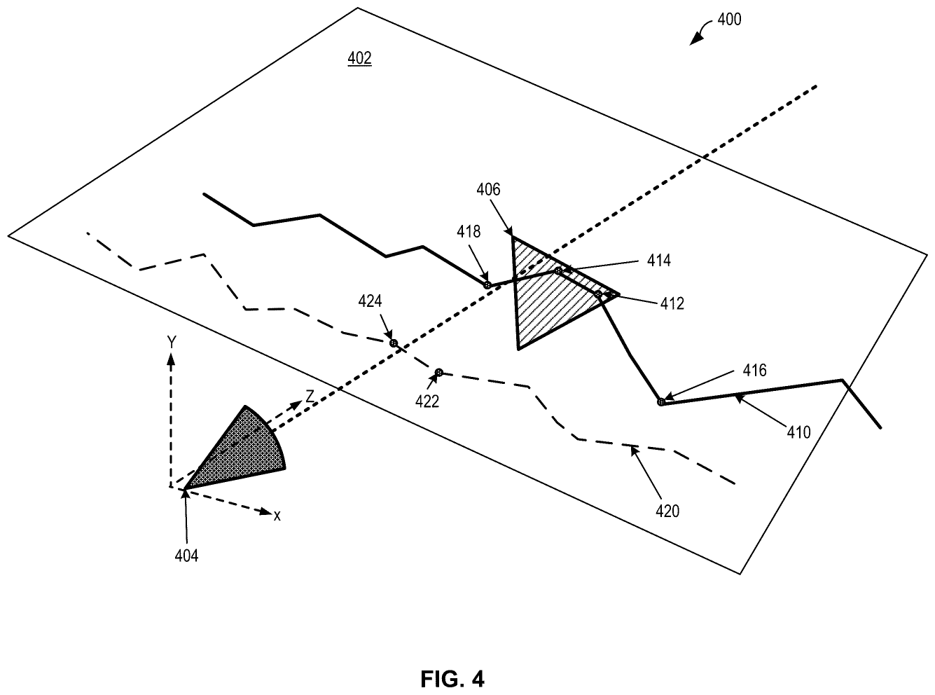

FIG. 4 illustrates an example diagram 400 of applying a depth bias to a three-dimensional contour line. A three-dimensional map 402 can be viewed from viewpoint 404. The three-dimensional map 402 can include different three-dimensional meshes, such as a terrain mesh. The terrain mesh can include one or more terrain polygons such as terrain polygon 406. A three-dimensional contour line 410 can be generated to add to the three-dimensional map 402. One or more segments of three-dimensional contour line 410 can intersect the terrain polygon 406. The one or more segments of the three-dimensional contour line can be segments between two points on the three-dimensional contour line, such as a first point 412 and a second point 414. Here, the first point 412 and the second point 414 are located behind the terrain polygon 406 with respect to the viewpoint 404. As such, the three-dimensional contour line 410 appears to clip into the terrain polygon 406 when viewed from the viewpoint 404. A depth bias can be applied to one or more segments of the three-dimensional contour line 410. In some examples, a depth bias can be applied to the entire three-dimensional contour line to form a second three-dimensional contour line 420. The depth bias can move the first point 412 and the second point 414 to a third point 422 and fourth point 424, respectively. The depth bias can be a vector.

In some examples, a depth bias can be applied to the one or more segments completely obscured by the terrain polygon 406. For example, a depth bias can be applied to the segment between the first point 412 and the second point 414, but not the rest of the three-dimensional contour line 410. In some examples, a depth bias can also be applied to the one or more segments partially obscured by the terrain mesh 446. For example, a depth bias can be applied to the segment between the first point 412 and the fifth point 416 and the segment between the second point 414 and the sixth point 418, but not the rest of the three-dimensional contour line 410. In some examples, a depth bias can be applied to the points obscured by the terrain polygon 406. For example, a depth bias can be applied to the first point 412 and the second point 414, but not the rest of the three-dimensional contour line 410. In some examples, when applying a depth bias to only a portion of the three-dimensional contour line 410, no other points or segments of the three-dimensional contour line 410 move. In some examples, adjacent segments and/or points have a partial depth bias applied to them that is percentage scale of the depth bias. In some examples, new segments are added to three-dimensional contour line 410 to connect the points and/or segments to which the depth bias was applied.

In some examples, the depth bias can be a predetermined value such as a constant. In some examples, the depth bias can be determined based on the characteristics of the contour line 410. For example, the depth bias can be a scalar applied to the slope of the contour line 410 in relation to the viewpoint 404. As the slope of the contour line 410 in relation to the viewpoint 404 increases, the depth bias to apply increases. In some examples, the depth bias can be determined based on the characteristics of the terrain polygon 406. For example, the depth bias can be a scalar applied to the slope of the terrain polygon 406 in relation to the viewpoint 404. As the slope of the terrain polygon 406 in relation to the viewpoint 404 increases, the depth bias to apply increases. In some examples, the depth bias can be a set of different depth biases that can be applied in different situations. For example, each depth bias of the set of depth biases can apply to different segments of the three-dimensional contour line 410. In some examples, each depth bias of the set of depth biases can be determined.

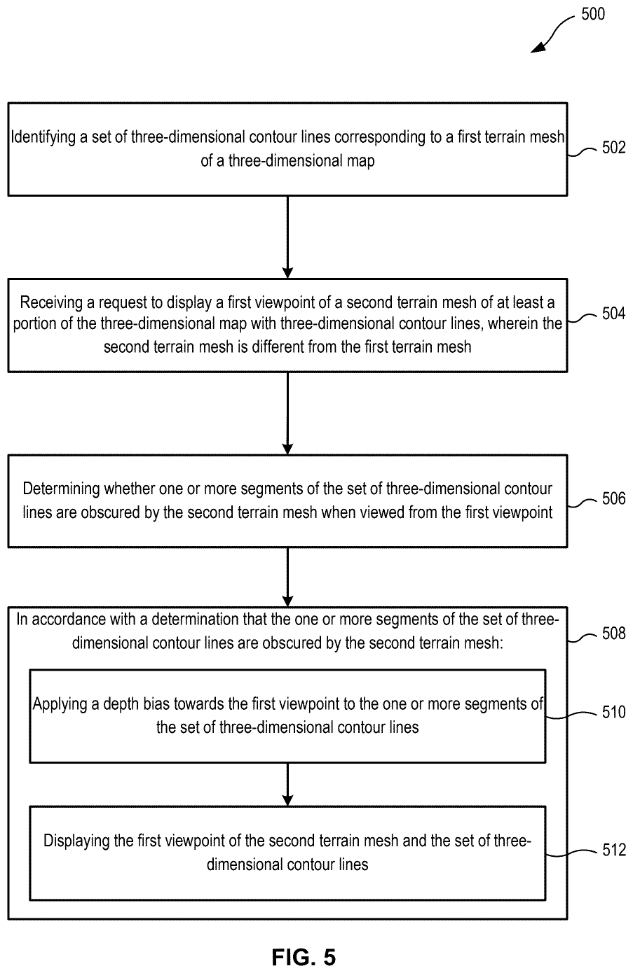

FIG. 5 illustrates a flow chart showing an example process 500 for generating three-dimensional contour lines on a three-dimensional map, according to at least one example. Process 500 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 502, the process 500 can include identifying a set of three-dimensional contour lines (for example, three-dimensional contour lines 336 of FIG. 3) corresponding to a first terrain mesh (for example, the second terrain mesh 334 of FIG. 3) of a three-dimensional map. At least one three-dimensional contour line of the set of three-dimensional contour lines can include segments with more than one z-axis value. The set of three-dimensional contour lines can be generated from a set of two-dimensional contour lines (for example, the two-dimensional contour lines 332 of FIG. 3) corresponding to the three-dimensional map and the first terrain mesh.

At block 504, the process 500 can include receiving a request to display a first viewpoint of a second terrain mesh (for example, the third terrain mesh 338 of FIG. 3) of at least a portion of the three-dimensional map with three-dimensional contour lines. The second terrain mesh can be different from the first terrain mesh. The second terrain mesh can correspond to a subsection of the three-dimensional map. The second terrain mesh can be a higher fidelity representation of the subsection than a corresponding portion of the first terrain mesh. The second terrain mesh can be a higher density three-dimensional mesh of the subsection than a corresponding three-dimensional mesh of the first terrain mesh. The second terrain mesh can correspond to a different zoom level than the first terrain mesh.

At block 506, the process 500 can include determining whether one or more segments (for example, the segments 214, 224 of FIG. 2) of the set of three-dimensional contour lines are obscured by the second terrain mesh when viewed from the first viewpoint. Determining whether one or more segments of the set of three-dimensional contour lines are obscured by the second terrain mesh when viewed from the first viewpoint can include determining one or more segments of the set of three-dimensional contour lines intersect the second terrain mesh.

At block 508, the process 500 can include one or more elements (for example, blocks 510, 512) in accordance with a determination that the one or more segments of the set of three-dimensional contour lines are obscured by the second terrain mesh. At block 510, the process 500 can include applying a depth bias towards the first viewpoint to the one or more segments of the set of three-dimensional contour lines. Applying the depth bias towards the first viewpoint to the one or more segments of the set of three-dimensional contour lines can include, for each segment of the one or more segments, determining the individual depth bias based at least in part on a terrain slope for a section of the second terrain mesh corresponding to the one or more segments. Applying the depth bias towards the first viewpoint to the one or more segments of the set of three-dimensional contour lines can include, for each segment of the one or more segments, applying the individual depth bias towards the first viewpoint. The depth bias can be selected from a predetermined set of values. The depth bias can include a set of depth biases. Each individual depth bias of the set of depth biases can correspond to a segment of the one or more segments. At block 512, the process 500 can include displaying the first viewpoint of the second terrain mesh and the set of three-dimensional contour lines.

The process 500 can further include generating the set of three-dimensional contour lines based at least in part on a set of two-dimensional contour lines corresponding to the three-dimensional map and the first terrain mesh. The process 500 can further include generating the set of two-dimensional contour lines based on a third terrain mesh (for example, the first terrain mesh 330 of FIG. 3) of the three-dimensional map. The third terrain mesh can be different from the first terrain mesh and the second terrain mesh. The process 500 can further include receiving, from a server, the set of three-dimensional contour lines.

The process 500 can further include receiving a second request to display a second viewpoint of a third terrain mesh (for example, the fourth terrain mesh 340 of FIG. 3) of at least a second portion of the three-dimensional map with three-dimensional contour lines. The third three-dimensional terrain mesh can be different from the first terrain mesh and the second terrain mesh. The process 500 can further include determining that a second set of one or more segments of the set of three-dimensional contour lines are obscured by the third three-dimensional terrain mesh when viewed from the second viewpoint. The process 500 can further include applying a second depth bias towards the second viewpoint to the second set of one or more segments of the set of three-dimensional contour lines. The process 500 can further include displaying the second viewpoint of the third terrain mesh and the set of three-dimensional contour lines.

In some examples, the first viewpoint can be associated with a first pitch value. The process 500 can further include receiving a request to generate a second viewpoint of the three-dimensional map. The second viewpoint can be associated with a second pitch value. The second pitch value can be different than the first pitch value. The process 500 can further include displaying the second viewpoint of the three-dimensional map. The process 500 can further include in response to displaying the second viewpoint, adjusting one or more opacity values associated with the set of three-dimensional contour lines based at least in part on the second pitch value.

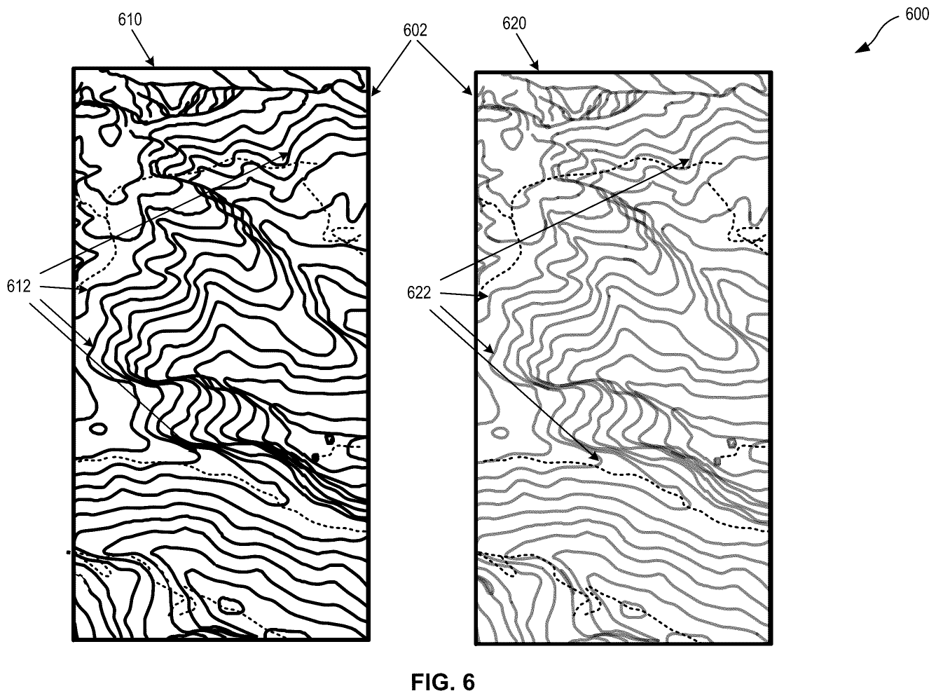

FIG. 6 illustrates a progression of three-dimensional 600 of viewpoints 610, 620 of the three-dimensional map 602 in order to illustrate techniques related to animating three-dimensional contour lines 612, 622 when changing pitch values of a viewpoint of the three-dimensional map 602. Three-dimensional contour lines are most useful when viewing a three-dimensional map from a bird's eye view (for example, a viewpoint with 0-degree pitch value). As a user increases the pitch of their viewpoint of the three-dimensional map, the user can see more three-dimensional information represented such as z-axis information. At this point, three-dimensional contour lines may be less useful. The three-dimensional contour lines can be animated to fade as the pitch of a viewpoint increases. For example, the three-dimensional contour lines 622 are faded compared to the three-dimensional contour lines 612. Creating the fading effect can be done by lowering the opacity of the three-dimensional contour lines. For example, the three-dimensional contour lines 622 may have 10-90% opacity of the three-dimensional contour lines 612.

In some examples, opacity of the three-dimensional contour lines can decrease as the pitch value of the viewpoint increases. This can form a gradient of opacity values that can be applied to the three-dimensional contour lines. In some examples, different contour lines can be associated with different opacities of a set of opacities. For example, the contour lines that are closer to the viewpoint can be more opaque than the contour lines that are further from the viewpoint. In some examples, there is a minimum opacity value. In some examples, the segments of the contour lines that are closer to the viewpoint can be more opaque than the segments of the contour lines that are further from the viewpoint. In this way, a single contour line may be associated with multiple opacity values. For example, a minimum opacity value can be 5%, 10%, 20% or any other suitable percentage opacity. In some examples, the minimum opacity value is associated with multiple pitch values. For example, the minimum opacity value may be associated with pitch values of 60 degrees or greater, or any other suitable range of pitch values. In some examples, there is a maximum opacity value. For example, a maximum opacity value can be 80%, 90%, or 100% opacity or any other suitable percentage opacity. In some examples, the maximum opacity value is associated with multiple pitch values. For example, the maximum opacity value may be associated with pitch values of 30 degrees or less, or any other suitable range of pitch values.

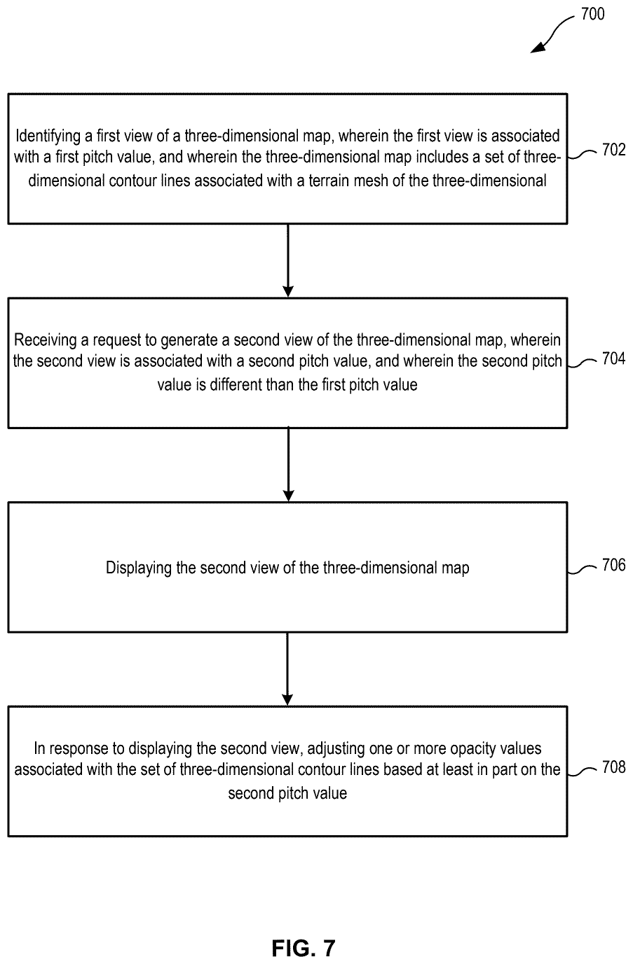

FIG. 7 illustrates a flow chart showing an example process 700 for generating three-dimensional contour lines on a three-dimensional map, according to at least one example. Process 700 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 702, the process 700 can include identifying a first view (for example, viewpoint 610 of FIG. 6) of a three-dimensional map. The first view can be associated with a first pitch value. The three-dimensional map can include a set of three-dimensional contour lines (for example, contour lines 612 of FIG. 6) associated with a terrain mesh of the three-dimensional map. The first pitch value can represent a z-axis angle. At least one three-dimensional contour line of the set of three-dimensional contour lines can include segments with more than one z-axis value.

At block 704, the process 700 can include receiving a request to generate a second view (for example, viewpoint 620 of FIG. 6) of the three-dimensional map. The second view can be associated with a second pitch value. The second pitch value can be different than the first pitch value.

At block 706, the process 700 can include displaying the second view of the three-dimensional map.

At block 708, the process 700 can include in response to displaying the second view, adjusting one or more opacity values associated with the set of three-dimensional contour lines (for example, contour lines 622 of FIG. 6). Adjusting the one or more opacity values can include decreasing opacity as the pitch value increases. The one or more opacity values can have a minimum opacity value. The minimum opacity value can be associated with a first set of pitch values. A first three-dimensional contour line that is closer to the second view can have a greater opacity value than a second three-dimensional contour line that is further from the second view. A maximum opacity is associated with a second set of pitch values. Adjusting one or more opacity values associated with the set of three-dimensional contour lines can be based at least in part on a gradient of opacity values.

The first view can be associated with a first set of one or more opacity values. The second view can be associated with a second set of one or more opacity values. The first pitch value can be less than the second pitch value. The process 700 can further include receiving a request to generate a third view of the three-dimensional map. The third view can be associated with a third pitch value. The third pitch value can be greater than the first pitch value and less than the second pitch value. The process 700 can further include displaying the third view of the three-dimensional map. The process 700 can further include in response to displaying the third view, adjusting the one or more opacity values associated with the set of three-dimensional contour lines. At least one of the one or more opacity values can be less than the first set of one or more opacity values. At least one of the one or more opacity values associated can be greater than the second set of one or more opacity values.

The set of three-dimensional contour lines can correspond to a first terrain mesh of the three-dimensional map. The process 700 can further include determining whether one or more segments of the set of three-dimensional contour lines are obscured by a second terrain mesh when viewed from the second view. In accordance with a determination that the one or more segments of the set of three-dimensional contour lines are obscured by the second terrain mesh, the process 700 can further include applying a depth bias towards the second view to the one or more segments of the set of three-dimensional contour lines. In accordance with a determination that the one or more segments of the set of three-dimensional contour lines are obscured by the second terrain mesh, the process 700 can further include displaying the second view of the second terrain mesh and the set of three-dimensional contour lines.

In some examples, the techniques described in relation to FIGS. 2-5 and the techniques described in relation to FIGS. 6-7 can be used in combination to generate three-dimensional contour lines.

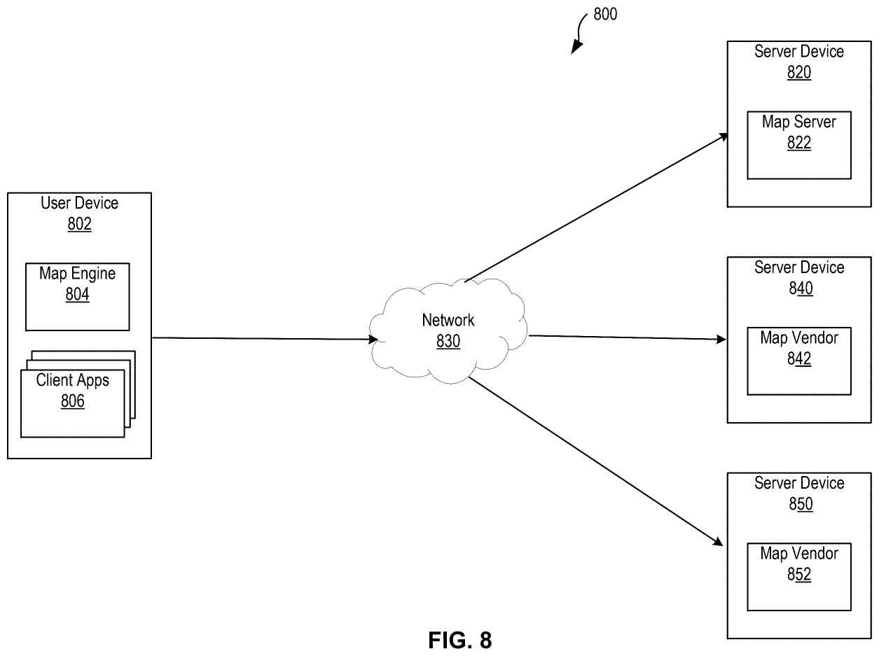

FIG. 8 illustrates a block diagram of an example system 800 for generating maps (including three-dimensional maps) based on map data (for example, terrain meshes, two-dimensional contour lines, and three-dimensional contour lines) obtained from different sources.

For example, system 800 can be configured to obtain map data from different sources (for example, map data vendors), stitch the map data from the different sources together, and generate a map that represents the map data received from the various sources. When stitching together the map data system 800 can make adjustments to the map data to avoid errors, discrepancies, and map appearance problems, as described in detail below.

In some implementations, system 800 can include user device 802. For example, user device 802 can be a computing device such as a laptop computer, desktop computer, smartphone, wearable device (for example, smartwatch, smart glasses, etc.), an in-vehicle infotainment system, and/or other computing device. User device 802 can include a built-in display and/or may be connected to an external display (for example, television, computer monitor, in-car system, smart glasses, etc.) using a wired and/or wireless connection. User device 802 can present graphical user interfaces generated by various software components (for example, operating system, user-level applications, etc.) installed and/or running on user device 802 on the built-in display and/or the connected external display.

In some implementations, user device 802 can include a map engine 804. The map engine 804 can enable client applications 806 on the user device 802 to access the map data received through the map data system 800. The map engine 804 can also process map-related data, for example as provided by a map vendor 842, 852 or a map server 822. In some implementations, client applications 806 can obtain map data from a map server to present the various types of maps and/or map data. Client applications 806 can then process the map data received from the map server to generate the graphical user interfaces presented on the display of user device 802. For example, client applications 806 can obtain the map data from map server 822 running on server device 820 through network 830 (for example, a local area network, wide area network, wireless network, cellular data network, the Internet, etc.). In some implementations, the parts of the particular techniques described herein can be performed on the user device 802. In some implementations, one or more techniques described herein can be performed on the user device 802. In some implementations, the techniques described herein can be performed by the map engine 804. In some implementations, the techniques described herein can be performed by the cline applications 806. For example, the techniques described in relation to FIGS. 1-7 can be performed on the user device 802, by the map engine 804, and/or the client applications 806.

In some implementations, the user device may have client applications 806 that access map data through the map engine 804. For example, a navigation application for providing directions can be one of the client applications 806. Client applications 806 can generate and/or present graphical user interfaces for presenting map data on a display (for example, built-in, external, etc.) of user device 802. Client applications 806 can present various types of maps that represent various types of map data. For example, client applications 806 can present maps that represent elevation, vegetation, coastlines, landcover, precipitation, and/or other data, as may be described herein. An example client application could be a navigation application. A navigation application can provide graphical user interfaces that allow the user to specify route parameters (for example, start location, destination location, transportation mode, etc.) and request navigation instructions based on the specified route parameters. A navigation application can present recommended routes based on the user specified route parameters and present navigation instructions for a route selected by the user.

In some implementations, system 800 can include server device 820. For example, server device 820 can be a computing device configured to host map server 822. Map server 822 can be a software server, or collection of software servers, configured to generate map data, maps, routing data, and/or routes for client devices (for example, user device 802) and/or client applications 806. In some implementations, one or more techniques described herein can be performed on the server device 820. In some implementations, the techniques described herein can be performed by the map server 822. For example, the techniques described in relation to FIGS. 1-7 can be performed on the server device 820 and/or the map server 822. In some implementations, the two-dimensional contour lines, three-dimensional contour lines, and terrain meshes are generated by the server device 820 and/or the map server 822. The two-dimensional contour lines, three-dimensional contour lines, and terrain meshes can be transmitted to the user device 802. Depth biasing can be performed at either the user device 802 or the server device by the map engine 804, the client applications 806, and/or the map server 822.

In some implementations, map server 822 can obtain map data from various map data vendors. For example, different map data vendors may specialize in different types of map data. For example, various, different map vendors may specialize in and/or provide high quality terrain elevation data, marine elevation data, climate data, land cover data, etc. Thus, map server 822 may obtain different types of map data from different sources or vendors. Map server 822 can combine the different types of map data received from different map vendors into a combined map data that can be served to client apps 806 or map engine 804 on user device 802.

In some implementations, system 800 can include server device 840 and/or server device 850. For example, server device 840, 850 can be a computing device connected to network 830. Server device 840, 850 be configured to communicate with server device 820 through network 830 to deliver vendor map data to server device 820. For example, server device 840, 850 can include map vendor servers 842, 852 (for example, software servers) that process vendor map data and serve the vendor map data to map server 822 on server device 820. Map vendor 852 can, for example, manage and serve terrain elevation map data to map server 822, while map vendor 842 may manage and serve land cover data (for example, vegetation, forest, urban shrubland, etc.) to map server 822. Map vendor 842 can be associated with a different type of vendor map data than map vendor 852. Map vendor 842 can be associated with the same type of vendor map data as map vendor 852. Map vendor 842, 852 can manage and serve any type of map data, including the various types of map data as may be described herein.

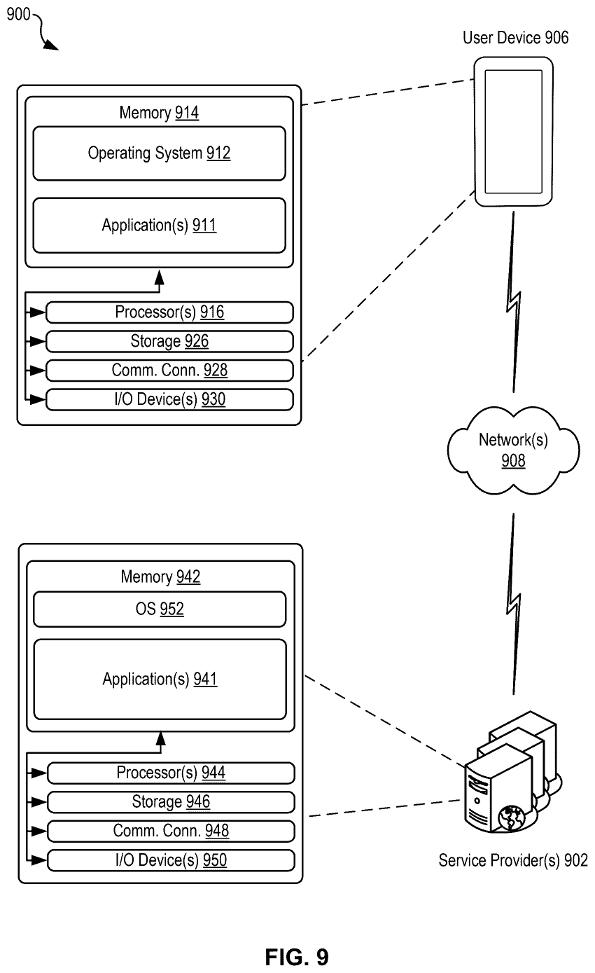

FIG. 9 illustrates an example architecture or environment 900 configured to implement techniques described herein, according to at least one example. In some examples, the example architecture 900 may further be configured to enable a user device 906 and service provider computer 902 to share information. The service provider computer 902 is an example of the map server 822 and the map vendors 842, 852. The user device 906 is an example of the user devices 802. In some examples, the devices may be connected via one or more networks 908 (e.g., via Bluetooth, WiFi, the Internet). In some examples, the service provider computer 902 may be configured to implement at least some of the techniques described herein with reference to the user device 906 and vice versa.

In some examples, the networks 908 may include any one or a combination of many different types of networks, such as cable networks, the Internet, wireless networks, cellular networks, satellite networks, other private and/or public networks, or any combination thereof. While the illustrated example represents the user device 906 accessing the service provider computer 902 via the networks 908, the described techniques may equally apply in instances where the user device 906 interacts with the service provider computer 902 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 906 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 906 may be in communication with the service provider computer 902 via the network 908, or via other network connections.

In one illustrative configuration, the user device 906 may include at least one memory 914 and one or more processing units (or processor(s)) 916. The processor(s) 916 may be implemented as appropriate in hardware, computer-executable instructions, firmware, or combinations thereof. Computer-executable instruction or firmware implementations of the processor(s) 916 may include computer-executable or machine-executable instructions written in any suitable programming language to perform the various functions described. The user device 906 may also include geo-location devices (e.g., a global positioning system (GPS) device or the like) for providing and/or recording geographic location information associated with the user device 906.

The memory 914 may store program instructions that are loadable and executable on the processor(s) 916, as well as data generated during the execution of these programs. Depending on the configuration and type of the user device 906, the memory 914 may be volatile (such as random access memory (RAM)) and/or non-volatile (such as read-only memory (ROM), flash memory). The user device 906 may also include additional removable storage and/or non-removable storage 926 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 914 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 914 and the additional storage 926, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 914 and the additional storage 926 are both examples of non-transitory computer-storage media. Additional types of computer-storage media that may be present in the user device 906 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 906. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 906 may also contain communications connection(s) 928 that allow the user device 906 to communicate with a data store, another computing device or server, user terminals, and/or other devices via the network 908. The user device 906 may also include I/O device(s) 930, such as a keyboard, a mouse, a pen, a voice input device, a touch screen input device, a display, speakers, and a printer.

Turning to the contents of the memory 914 in more detail, the memory 914 may include an operating system 913 and/or one or more application programs or services for implementing the features disclosed herein such as applications 911 (e.g., the map engine 804, client apps 806, health application, digital wallet, third-party applications, browser application). In some examples, the applications 911 may include map-related applications (e.g., the map engine 804, client apps 806) to perform similar techniques as described with reference to the user device 906. Applications 911 (e.g., the map engine 804, client apps 806) can perform some or all the techniques as described with reference to FIGS. 1-7. Similarly, at least some techniques described with reference to the service provider computer 902 may be performed by the user device 906.

The service provider computer 902 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 902 may be in communication with the user device 906 via the network 908, or via other network connections.

In one illustrative configuration, the service provider computer 902 may include at least one memory 942 and one or more processing units (or processor(s)) 944. The processor(s) 944 may be implemented as appropriate in hardware, computer-executable instructions, firmware, or combinations thereof. Computer-executable instruction or firmware implementations of the processor(s) 944 may include computer-executable or machine-executable instructions written in any suitable programming language to perform the various functions described.

The memory 942 may store program instructions that are loadable and executable on the processor(s) 944, as well as data generated during the execution of these programs. Depending on the configuration and type of service provider computer 902, the memory 942 may be volatile (such as RAM) and/or non-volatile (such as ROM and flash memory). The service provider computer 902 may also include additional removable storage and/or non-removable storage 946 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 942 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 942 and the additional storage 946, both removable and non-removable, are both additional examples of non-transitory computer-readable storage media.

The service provider computer 902 may also contain communications connection(s) 948 that allow the service provider computer 902 to communicate with a data store, another computing device or server, user terminals, and/or other devices via the network 908. The service provider computer 902 may also include I/O device(s) 950, such as a keyboard, a mouse, a pen, a voice input device, a touch input device, a display, speakers, and a printer.

Turning to the contents of the memory 942 in more detail, the memory 942 may include an operating system 952 and/or one or more application programs 941 or services for implementing the features disclosed herein. For example, the services and applications associated with or corresponding to the map server 822, and map vendors 842, 852 correspond to applications 941 on the service providers 902, such that the server devices 820, 840, 850 may include other applications for other features and/or services. Applications 941 (e.g., the map server 822) can perform some or all of the techniques as described with reference to FIGS. 1-7.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft® Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A computer-implemented method, comprising:
receiving a request to display a first viewpoint of a first terrain mesh of at least a portion of a three-dimensional map including a set of three-dimensional contour lines;
determining whether one or more segments of the set of three-dimensional contour lines are obscured by the first terrain mesh when viewed from the first viewpoint; and
in accordance with a determination that the one or more segments of the set of three-dimensional contour lines are obscured by the first terrain mesh:
applying a depth bias towards the first viewpoint to the one or more segments of the set of three-dimensional contour lines; and
displaying the first viewpoint of the first terrain mesh and the set of three-dimensional contour lines.

2. The method of claim 1, further comprising generating the set of three-dimensional contour lines based at least in part on a set of two-dimensional contour lines corresponding to the three-dimensional map and a second terrain mesh of at least a second portion of the three-dimensional map.

3. The method of claim 2, further comprising generating the set of two-dimensional contour lines based on a third terrain mesh of the three-dimensional map.

4. The method of claim 3, wherein the third terrain mesh is different from the first terrain mesh and the second terrain mesh.

5. The method of claim 2, wherein the first terrain mesh is different from the second terrain mesh.

6. The method of claim 1, further comprising receiving, from a server, the set of three-dimensional contour lines, wherein the set of three-dimensional contour lines is generated from a set of two-dimensional contour lines corresponding to the three-dimensional map and a second terrain mesh of at least a second portion of the three-dimensional map.

7. The method of claim 1, wherein the depth bias is selected from a predetermined set of values.

8. One or more non-transitory computer-readable media comprising computer-executable instructions that, when executed by one or more processors, cause the one or more processors to perform operations comprising:
receiving a request to display a first viewpoint of a first terrain mesh of at least a portion of a three-dimensional map including a set of three-dimensional contour lines;
determining whether one or more segments of the set of three-dimensional contour lines are obscured by the first terrain mesh when viewed from the first viewpoint; and
in accordance with a determination that the one or more segments of the set of three-dimensional contour lines are obscured by the first terrain mesh:
applying a depth bias towards the first viewpoint to the one or more segments of the set of three-dimensional contour lines; and
displaying the first viewpoint of the first terrain mesh and the set of three-dimensional contour lines.

9. The one or more non-transitory computer-readable media of claim 8, wherein the depth bias comprises a set of depth biases, wherein each individual depth bias of the set of depth biases corresponds to a particular segment of the one or more segments.

10. The one or more non-transitory computer-readable media of claim 9, wherein applying the depth bias towards the first viewpoint to the one or more segments of the set of three-dimensional contour lines includes:
for each particular segment of the one or more segments, determining the individual depth bias based at least in part on a terrain slope for a section of the first terrain mesh corresponding to the one or more segments; and
for each particular segment of the one or more segments, applying the individual depth bias towards the first viewpoint.

11. The one or more non-transitory computer-readable media of claim 8, comprising further computer-executable instructions that, when executed by one or more processors, cause the one or more processors to perform operations comprising:
receiving a second request to display a second viewpoint of a second terrain mesh of at least a second portion of the three-dimensional map with three-dimensional contour lines, wherein the second terrain mesh is different from the first terrain mesh;
determining that a second set of one or more segments of the set of three-dimensional contour lines are obscured by the second terrain mesh when viewed from the second viewpoint;
applying a second depth bias towards the second viewpoint to the second set of one or more segments of the set of three-dimensional contour lines; and
displaying the second viewpoint of the second terrain mesh and the set of three-dimensional contour lines.

12. The one or more non-transitory computer-readable media of claim 11, wherein the second viewpoint has a different pitch or a different zoom level than the first viewpoint.

13. The one or more non-transitory computer-readable media of claim 8, wherein the first terrain mesh corresponds to a subsection of the three-dimensional map.

14. The one or more non-transitory computer-readable media of claim 13, wherein the first terrain mesh is a higher fidelity representation of the subsection than a corresponding portion of a second terrain mesh used to generate the set of three-dimensional contour lines.

15. The one or more non-transitory computer-readable media of claim 13, wherein the first terrain mesh is a higher density three-dimensional mesh of the subsection than a corresponding three-dimensional mesh of a second terrain mesh used to generate the set of three-dimensional contour lines.

16. A computer system, comprising:
a memory configured to store computer-executable instructions; and
a processor configured to access the memory and execute the computer-executable instructions to:
receive a request to display a first viewpoint of a first terrain mesh of at least a portion of a three-dimensional map including a set of three-dimensional contour lines;
determine whether one or more segments of the set of three-dimensional contour lines are obscured by the first terrain mesh when viewed from the first viewpoint; and
in accordance with a determination that the one or more segments of the set of three-dimensional contour lines are obscured by the first terrain mesh:
apply a depth bias towards the first viewpoint to the one or more segments of the set of three-dimensional contour lines; and
display the first viewpoint of the first terrain mesh and the set of three-dimensional contour lines.

17. The computer system of claim 16, wherein the first terrain mesh corresponds to a different zoom level than a second terrain mesh used to generate the set of three-dimensional contour lines.

18. The computer system of claim 16, wherein determining that the one or more segments of the set of three-dimensional contour lines are obscured by the first terrain mesh when viewed from the first viewpoint includes determining the one or more segments of the set of three-dimensional contour lines intersect the first terrain mesh.

19. The computer system of claim 16, wherein the first viewpoint is associated with a first pitch value, and wherein the one or more processors in communication with the memory is further configured to access the memory and execute the computer-executable instructions to:
receive a request to generate a second viewpoint of the three-dimensional map, wherein the second viewpoint is associated with a second pitch value, and wherein the second pitch value is different than the first pitch value;
display the second viewpoint of the three-dimensional map; and
in response to displaying the second viewpoint, adjust one or more opacity values associated with the set of three-dimensional contour lines based at least in part on the second pitch value.

20. The computer system of claim 16, wherein at least one three-dimensional contour line of the set of three-dimensional contour lines includes segments with more than one z-axis value.
